(19) United States
(12) Patent Application Publication
(10) Pub. No.: US 2026/0251179 A1
(43) Pub. Date: Aug. 27, 2026

(54) RESIN HOLDER FOR BALL BEARING, BALL BEARING, AND METHOD FOR MANUFACTURING RESIN HOLDER FOR BALL BEARING

(71) Applicants: NSK LTD., Tokyo (JP); TAKAI SEIKI CO., LTD., Kanagawa (JP)

(72) Inventors: Hironori SUZUKI, Kanagawa (JP); Yamato OKAZAKI, Kanagawa (JP); Ryohei TAKAYAMA, Kanagawa (JP)

(73) Assignees: NSK LTD., Tokyo (JP); TAKAI SEIKI CO., LTD., Kanagawa (JP)

(21) Appl. No.: 18/854,799

(22) PCT Filed: Mar. 8, 2023
(86) PCT No.: PCT/JP2023/008938

§ 371 Date: Oct. 7, 2024

(30) Foreign Application Priority Data
Apr. 8, 2022 (JP) 2022-064691

(51) Int. Cl. F16C 33/38; F16C 19/06

(52) U.S. Cl. CPC F16C 33/3856; F16C 19/06; F16C 33/3806; F16C 33/416; F16C 2208/36; F16C 2208/52; F16C 2208/70; F16C 2220/04

(57) ABSTRACT

A resin cage includes at least one annular portion, a plurality of column portions each extending from the annular portion in an axial direction and provided at equal intervals in a circumferential direction, and pockets formed between adjacent column portions. The annular portion has a guide surface that is guided by an inner circumferential surface of an outer ring or an outer circumferential surface of an inner ring, and a gate G for injection-molding the resin cage is provided on an inner circumferential surface of all the column portions, and is displaced in the circumferential direction from a circumferential center position of each column portion. The gate is provided within a range where an inner ring raceway groove is formed in the axial direction, or within a range where the inner ring raceway groove and a counterbore of the inner ring are formed.

### TECHNICAL FIELD

The present invention relates to a resin cage for a ball bearing, a ball bearing, and a method for manufacturing a resin cage for a ball bearing, and for example, relates to a resin cage for a ball bearing, a ball bearing, and a method for manufacturing a resin cage for a ball bearing used in dental air turbines, cleaners, power tools, and the like.

### BACKGROUND ART

Generally, resin cages applied to rolling bearings are manufactured by injection-molding. Specifically, a cage is manufactured by forming an annular cavity corresponding to the cage in a mold, injecting a molten resin material (thermoplastic resin) through a resin injection gate provided at the peripheral edge of the cavity, and cooling and solidifying the same.

However, when the cage is formed with one or more gates, the shape of an outer circumferential surface and an inner circumferential surface that serve as guide surfaces tends to be an ellipse when there is one gate, a triangular shape when there are three gates, and a square shape when there are four gates. This is because the cooling rate differs between the gate part where the molten resin flows into the cavity, the weld portion where the molten resins are joined to each other, and other parts.

For example, when an inner ring guided cage 101 with an elliptical guide surface 102 shown in FIG. 14A is rotated at high speed, the cage 101 is rotated with a minor diameter portion and a major diameter portion of the guide surface 102 being in contact with an outer circumferential surface 104 of an inner ring 103 as shown in FIGS. 14B to 14D.

When the inner ring guide cage 101 having the triangular guide surface 102 shown in FIG. 15A is rotated at high speed, the cage 101 is rotated with the outer circumferential surface 104 of the inner ring 103 in contact with three large curvature portions and three small curvature portions of the guide surface 102 as shown in FIGS. 15B and 15C. Therefore, both of the resin cages 100 have a problem of large radial vibration amplitude. Such a problem also exists in the case of the cage of the outer ring guide.

In the resin cage described in Patent Literature 1, weld line formed on the inner and outer circumferential surfaces of the cage has an inclination angle of 17° or more with respect to the axis of the cage, and the relation between the cross-sectional area of the weld portion and the ratio of the cross-sectional area of the balls, and the relation between the cross-sectional area of the weld portion and the elongation of the crown type cage in the direction of fracture due to breaking load and tensile breaking load are satisfied, so that it is possible to manufacture products that have high breaking strength at the weld portion and have high durability even when subjected to vibrations and large bending moment loads. Therefore, in Patent Literature 1, when one or more gate parts are provided, the gate parts are provided on a non-chamfered edge of the edge on the outer circumferential side or the inner circumferential side disposed near the gate part, where the non-chamfered edge is formed of two surfaces of the outer circumferential surface or the inner circumferential surface and the end surface of the cage facing the wall surface of the pocket that intersect each other.

Patent Literature 2 describes a rolling bearing cage in which a first recess that corresponds to a gate position during molding, and a second recess that has the same shape as the first recess and avoids correspondence with the gate position are formed at equal intervals on the circumference in an annular portion of thermoplastic resin to improve the weight balance of the crown type cage and prevent the crown type cage from rattling during high-speed rotation.

### CITATION LIST

### Patent Literature

Patent Literature 1: JP2020-46069A

Patent Literature 2: JPH 08-291826A

### SUMMARY OF INVENTION

### Technical Problem

The present invention has been made in view of the problems described above, and an object is to provide a resin cage for a ball bearing, a ball bearing, and a method for manufacturing a resin cage for a ball bearing, in which the resin case for a ball bearing has a long service life and is quiet, by increasing a practical virtual roundness of a guide surface and significantly reducing a radial vibration amplitude during rotation.

### Solution to Problem

The above object of the present invention may be achieved by the following configurations.

[1] A resin cage for a rolling bearing, the resin cage including at least one annular portion, and a plurality of column portions each extending from the annular portion in an axial direction and provided at equal intervals in a circumferential direction, in which the resin cage for the ball bearing can rotatably hold balls of the ball bearing in pockets formed between adjacent column portions, the annular portion has a guide surface that is guided by an inner circumferential surface of an outer ring or an outer circumferential surface of an inner ring of the ball bearing,
gate marks are provided on inner circumferential surfaces of all of the column portions, and
the gate marks are circumferentially displaced from a circumferential center position of the column portions.

[2] The resin cage for the ball bearing according to [1], in which the guide surface is guided by the inner circumferential surface of the outer ring, and
the guide surface has an uneven circular shape having convex portions protruding radially outward on a phase of all the column portions with respect to a perfect circle.

[3] The resin cage for the ball bearing according to [2], in which the guide surface is formed by an outer circumferential surface of the annular portion having a larger outer diameter than an outer circumferential surface of the column portion.

[4] The resin cage for the ball bearing according to [2], in which the guide surface is formed by an outer circumferential surface of the annular portion having an outer diameter equal to an outer circumferential surface of the column portion, and
a U-shaped groove in which a parting line extends along the axial direction is formed on the outer circumferential surface of the annular portion and the column portion at a circumferentially intermediate position between the adjacent pockets.

[5] The resin cage for the ball bearing according to [1], in which the guide surface is guided by the outer circumferential surface of the inner ring, and
the guide surface has an uneven circular shape having a convex portion protruding radially inward on a phase of all the column portions with respect to a perfect circle.

[6] The resin cage for the ball bearing according to any one of [1] to [5], in which the resin cage is a crown type cage or a double ring type cage having a pair of annular portions.

[7] A ball bearing including:
an outer ring with an outer ring raceway groove formed on an inner circumferential surface;
an inner ring with an inner ring raceway groove formed on an outer circumferential surface;
a plurality of balls rotatably disposed between the outer ring raceway groove and the inner ring raceway groove; and
the resin cage for the ball bearing according to any one of [1] to [6], in which the gate mark is provided within a range where the inner raceway groove is formed in an axial direction, or within a range where the inner raceway groove and a counterbore of the inner ring are formed.

[8] A method for manufacturing a resin cage for a rolling bearing, the resin cage including at least one annular portion, and a plurality of column portions each extending from the annular portion in an axial direction and provided at equal intervals in a circumferential direction, in which the resin cage for the ball bearing can rotatably hold balls of the ball bearing in pockets formed between adjacent column portions, the annular portion has a guide surface that is guided by an inner circumferential surface of an outer ring or an outer circumferential surface of an inner ring of the ball bearing,
the resin cage is injection-molded using a radial draw mold,
gates are provided on the inner circumferential surface of all the column portions, and
the gates are circumferentially displaced from a circumferential center position of the column portion.

### Advantageous Effects of Invention

According to the resin cage for the ball bearing of the present invention, since the gate marks of the resin cage are provided on the inner circumferential surface of all the column portions, the practical virtual roundness of the guide surface of the resin cage that comes into contact with the inner circumferential surface of the outer ring or the outer circumferential surface of the inner ring is increased, and the radial vibration amplitude of the resin cage during rotation is significantly reduced, resulting in longer service life and quieter operation. Since the gate marks are circumferentially displaced from the circumferential center position of the column portion, the weld line can be circumferentially displaced from the pocket bottom surface, thereby improving the strength.

According to the ball bearing of the present invention, since the ball bearing resin cage described above is provided, and the gate marks are provided within the range where the inner ring raceway groove is formed in the axial direction, or within the range where the inner ring raceway groove and the counterbore of the inner ring are formed, the gate marks do not impede rotation.

According to the method for manufacturing a resin cage for a ball bearing of the present invention, since the resin cage is injection-molded using a radial draw mold, and the gates are provided on the inner circumferential surfaces of all the column portions, the practical virtual roundness of the guide surface of the resin cage that comes into contact with the inner circumferential surface of the outer ring or the outer circumferential surface of the inner ring is increased, and the radial vibration amplitude of the resin cage during rotation is significantly reduced, resulting in longer service life and quieter operation. Since the gates are circumferentially displaced from the circumferential center position of the column portion, the weld line can be circumferentially displaced from the pocket bottom surface, thereby improving the strength.

### BRIEF DESCRIPTION OF DRAWINGS

FIG. 1 is a longitudinal cross-sectional view of a main part of a deep groove ball bearing incorporating a crown type cage according to a first embodiment of the present invention.

FIG. 2 is a perspective view of the crown type cage shown in FIG. 1.

FIGS. 3A to 3C are schematic diagrams illustrating the relationship between a guide surface of the crown type cage and an inner circumferential surface of an outer ring.

FIG. 4 is a schematic diagram provided to explain a practical virtual roundness of a petal-shaped guide surface.

FIG. 5 is a longitudinal cross-sectional view of a main part of a deep groove ball bearing incorporating a crown type cage according to a second embodiment of the present invention.

FIGS. 6A to 6C are schematic diagrams illustrating the relationship between a guide surface of the crown type cage and an outer circumferential surface of an inner ring.

FIG. 7 is a perspective view of a crown type cage according to a modification of the present embodiment.

FIG. 8 is a longitudinal cross-sectional view of a main part of an angular contact ball bearing incorporating an outer ring guide type double ring type cage according to a third embodiment of the present invention.

FIG. 9 is a perspective view of the double ring type cage shown in FIG. 8.

FIG. 10 is a longitudinal cross-sectional view of a main part of an angular contact ball bearing incorporating an inner ring guide type double ring type cage according to a modification of the present embodiment.

FIG. 11 is a longitudinal cross-sectional view of a main part of an outer ring guide angular contact ball bearing incorporating a double ring type cage according to a fourth embodiment of the present invention.

FIG. 12 is a partial perspective view of the double ring type cage shown in FIG. 11.

FIG. 13 is a partial perspective view of a double ring type cage according to a modification of the fourth embodiment.

FIGS. 14A to 14D are schematic diagrams showing the positional relationship between an elliptical guide surface of a resin cage injection-molded from one gate and an outer circumferential surface of the inner ring.

FIGS. 15A to 15C are schematic diagrams showing the positional relationship between a triangular guide surface of a resin cage injection-molded from three gates and the outer circumferential surface of the inner ring.

### DESCRIPTION OF EMBODIMENTS

Hereinafter, a resin cage for a ball bearing according to each embodiment of the present invention, and a ball bearing incorporating the resin cage will be described in detail with reference to the drawings.

### First Embodiment

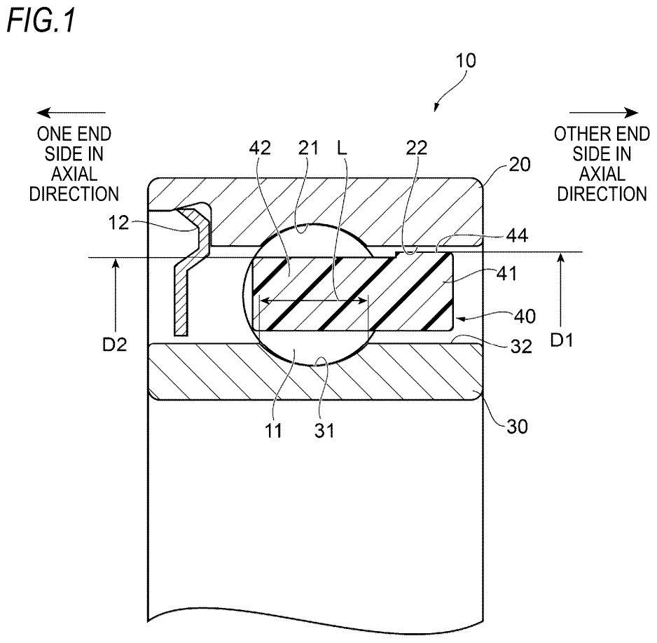

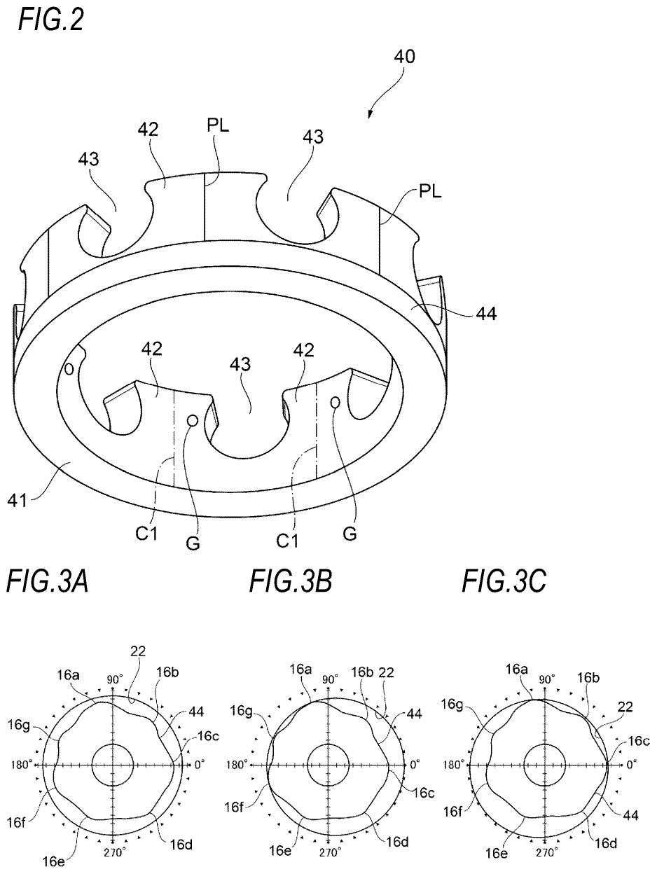

As shown in FIG. 1, a deep groove ball bearing 10 of the first embodiment includes an outer ring 20 with an outer ring raceway groove 21 formed on an inner circumferential surface, an inner ring 30 with an inner ring raceway groove 31 formed on an outer circumferential surface, a plurality of balls 11 rotatably disposed between the outer ring raceway groove 21 and the inner ring raceway groove 31, a crown type cage 40 that is a resin cage having a plurality of pockets 43 (see FIG. 2) that rotatably hold the balls 11, respectively, and a sealing member 12 attached to the inner circumferential surface of the outer ring 20 and seals between the outer ring 20 and the inner ring 30 on axial one side of the deep groove ball bearing 10.

As shown in FIG. 2, the crown type cage 40 includes an annular portion 41 and a plurality of (seven, in the present embodiment) column portions 42 each extending in the axial direction from one axial end of the annular portion 41 and arranged at equal intervals in the circumferential direction, and a plurality of (seven, in the present embodiment) pockets 43 for rotatably holding the balls 11 are formed between the adjacent column portions 42, respectively. A large-diameter outer circumferential surface 44 having an outer diameter D1 slightly larger than an outer diameter D2 of the column portion 42 is formed on the outer circumferential surface of the annular portion 41 as a guide surface. That is, the crown type cage 40 is an outer ring guide type cage in which the large-diameter outer circumferential surface 44 is guided by an inner circumferential surface 22 of a shoulder portion on the axial other side of the outer ring 20. Note that an inner surface of the pocket 43 has a cylindrical shape, but may have a spherical shape.

For the resin material for the crown type cage 40, a resin composition is used that is obtained by adding 10 to 50 wt % of reinforcing fiber material (for example, glass fiber or carbon fiber) to polyamide resins such as nylon 46 and nylon 66 and synthetic resins such as polybutylene terephthalate, polyphenylene sulfide (PPS), polyetheretherketone (PEEK), polyethernitrile (PEN), and polyethylene terephthalate (PET).

Although not shown, the crown type cage 40 is injection-molded by discharging a melted resin material from a gate into a cavity formed in a radial draw mold. In the present embodiment, there are gates open at positions corresponding to the inner circumferential surfaces of all the column portions 42 of the cavity, respectively. Therefore, as shown in FIG. 2, gate marks G are provided on the inner circumferential surfaces of all the column portions 42. In the circumferential direction, the gate mark G is circumferentially displaced from a circumferential center position C1 of the column portion 42, and in the axial direction, as shown in FIG. 1, the gate mark G is provided on the inner circumferential surface of the column portion 42, within a range L where the inner ring raceway groove 31 of the inner ring 30 is formed when the crown type cage 40 is assembled into the deep groove ball bearing 10.

By providing the gate mark G on the inner circumferential surface of the column portion 42 circumferentially displaced from the circumferential center position C1 of the column portion 42, a weld line (not shown) is formed at a position displaced in the circumferential direction from the bottom of the pocket 43 where the wall thickness is the smallest, and the cross-sectional area of the weld portion is increased, thereby improving the strength.

By providing the gate mark G within the range L where the inner ring raceway groove 31 of the inner ring 30 is formed, the gate mark G is located within the inner ring raceway groove 31, so that even if the inner circumferential surface of the cage 40 and the outer circumferential surface of the inner ring 30 come into contact with each other, interference between the gate mark G and an outer circumferential surface 32 of the shoulder portion of the inner ring 30 can be prevented, thereby eliminating the influence on rotation.

The pocket 43 of the crown type cage 40 is formed by a radial draw mold having a plurality of (seven, in the present embodiment) slide cores (movable type) (not illustrated) that are movable radially outward. Therefore, as shown in FIG. 2, parting lines PL, which are joints of the slide cores, are formed at the circumferential center of the outer circumferential surface of the column portions 42, respectively. Note that the outer circumferential surface (the large-diameter outer circumferential surface 44) and the inner circumferential surface of the annular portion 41 of the crown type cage 40 are cut out in the axial direction from a fixed mold forming the cavity, and so do not have a parting line PL.

Since the crown type cage 40 is injection-molded using resin discharged from a plurality of gates provided on the inner circumferential surface of all the column portions 42, the large-diameter outer circumferential surface 44, which is a guide surface of the crown type cage 40, is formed into an uneven (petal-shaped) circular shape having convex portions 16a to 16g that protrude radially outward on a phase of all the column portions 42 with respect to a perfect circle (see FIGS. 3A to 3C).

FIGS. 3A to 3C show three states in which the large-diameter outer circumferential surface 44 of the crown type cage 40, which is formed into a circular shape having the same number of the convex portions 16a to 16g as the column portions 42, is guided by the inner circumferential surface 22 of the shoulder portion of the outer ring 20, which is formed in a substantially circular shape. For example, as shown in FIG. 3B, when the inner circumferential surface 22 of the shoulder portion of the outer ring 20 is displaced diagonally downward to the right in the drawing relative to the crown type cage 40, the convex portions 16a, 16f and 16g come into contact with the inner circumferential surface 22 of the shoulder portion of the outer ring 20 to restrict further movement. As shown in FIG. 3C, when the inner circumferential surface 22 of the shoulder portion of the outer ring 20 is displaced diagonally downward to the left in the drawing relative to the large-diameter outer circumferential surface 44, the convex portions 16a and 16c come into contact with the inner circumferential surface 22 of the shoulder portion of the outer ring 20 to restrict further movement.

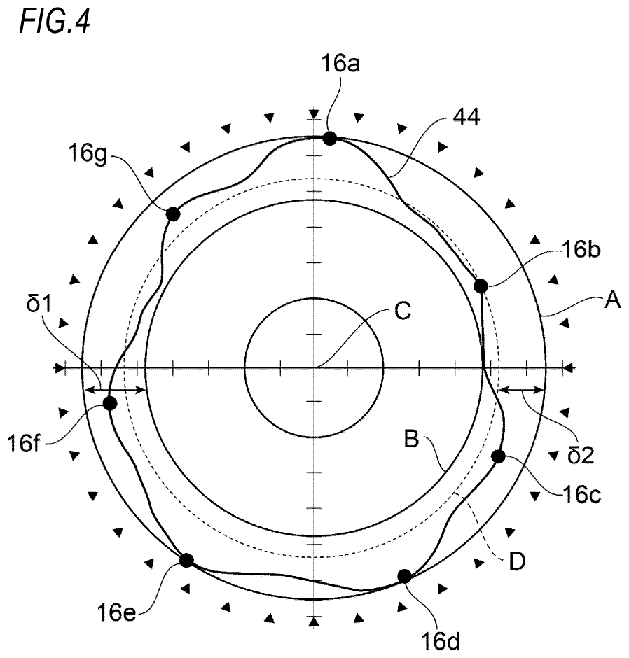

As shown in FIG. 4, the roundness of the large-diameter outer circumferential surface 44, which is formed in a petal shape and has the same number of the convex portions 16a to 16g as the column portions 42, is a radius difference 81 between two concentric circles, that is, a circle A that contacts the maximum diameter portion of the large-diameter outer circumferential surface 44 and a circle B that contacts the minimum diameter portion of the large-diameter outer circumferential surface 44 (for example, 8.63 μm in the present embodiment). Meanwhile, the distance over which the inner circumferential surface 22 of the shoulder portion of the outer ring 20 can actually move relatively in the radial direction is a radius difference 82 (for example, about 5.00 μm in the present embodiment) between two concentric circles, that is, a circle D which is in contact with the convex portion 16b having the shortest distance from the center C among the convex portions 16a to 16g, and the circle A. That is, the practical virtual roundness of the large-diameter outer circumferential surface 44 is the radius difference 82 between the two concentric circles, that is, the circle D and the circle A, which is smaller than the roundness (the radius difference 81) of the large-diameter outer circumferential surface 44.

Therefore, the inner circumferential surface 22 of the shoulder portion of the outer ring 20 does not come into contact with any of the concave portions formed between the respective convex portions 16a to 16g, and the practical virtual roundness is reduced. As a result, by having the same number of convex portions 16a to 16g as the column portions 42 on the large-diameter outer circumferential surface 44, the radial vibration amplitude of the outer ring-guided crown type cage 40 can be significantly reduced even in high-speed rotation under conditions of dmn of 1 million or more.

Note that the above-mentioned effects of the present embodiment are achieved as long as there are at least three column portions 42 and pockets 43 formed at equal intervals in the circumferential direction.

As explained above, according to the crown type cage 40 which is a resin cage for deep groove ball bearing of the present embodiment, since the gate marks G are provided on the inner circumferential surfaces of all the column portions 42, the practical virtual roundness of the guide surface of the crown type cage 40 can be increased, and the radial vibration amplitude of the crown type cage 40 during rotation can be significantly reduced, thereby making it possible to extend service life and to reduce noise. Since the gate mark G is circumferentially displaced from the circumferential center position of the column portion 42, the weld line can be circumferentially displaced from the pocket bottom surface, thereby improving the strength. According to the deep groove ball bearing 10 of the present embodiment, since the structure of the crown type cage 40 is as described above and the gate mark G is provided within the range where the inner ring raceway groove 31 is formed in the axial direction, the gate mark G does not impede rotation.

According to a method for manufacturing the crown type cage 40 for a ball bearing of the present embodiment, since the crown type cage 40 is injection-molded using a radial draw mold, and the gates are provided on the inner circumferential surfaces of all the column portions 42, the practical virtual roundness of the guide surface of the crown type cage 40 can be increased, and the radial vibration amplitude of the crown type cage 40 during rotation can be significantly reduced, thereby making it possible to extend service life and reduce noise. Since the gate is circumferentially displaced from the circumferential center position of the column portion 42, the weld line can be circumferentially displaced from the pocket bottom surface, thereby improving the strength.

### Second Embodiment

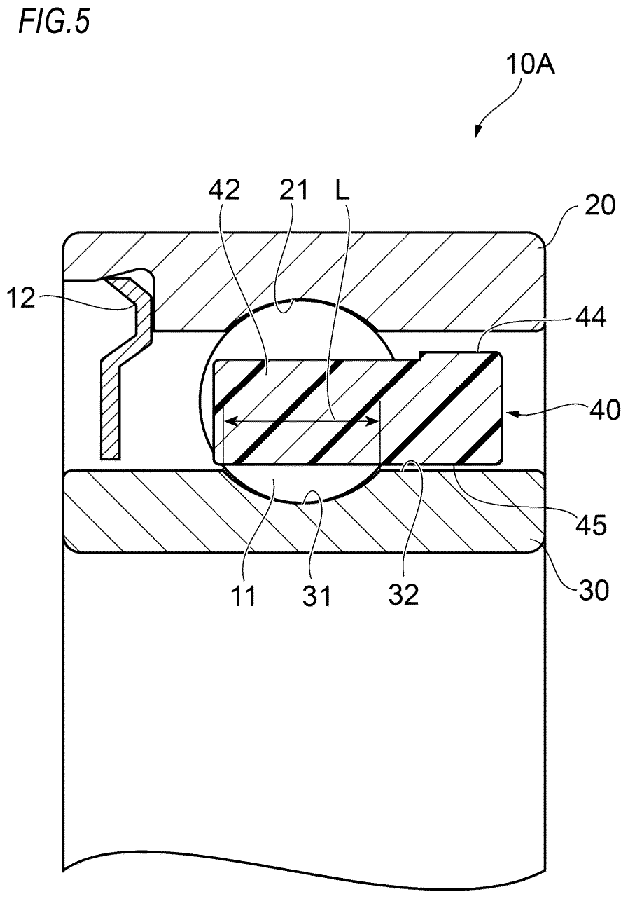

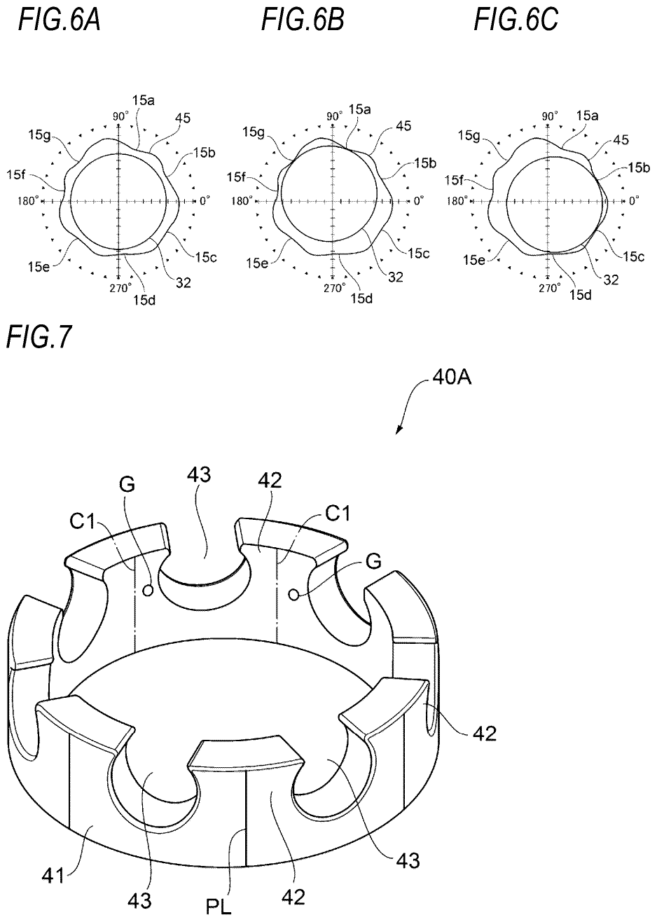

Next, a deep groove ball bearing incorporating a resin cage according to a second embodiment of the present invention will be described with reference to FIG. 5 and FIGS. 6A to 6C. Note that parts that are substantially the same as those in the first embodiment are designated by the same or equivalent numerals, and description thereof will be omitted.

In the present embodiment, the resin cage 40 of the first embodiment forms an inner ring guide type cage, and an inner circumferential surface 45 of the annular portion 41 is guided by the outer circumferential surface 32 of the shoulder portion of the inner ring 30 as a guide surface.

FIGS. 6A to 6C show the relationship between the inner circumferential surface 45 of the crown type cage 40 and the outer circumferential surface 32 of the shoulder portion of the inner ring 30. As in the first embodiment, when injection-molding is performed with the gates provided on the inner circumferential surfaces of all the column portions 42, the inner circumferential surface 45 of the crown type cage 40 is also formed into a petal shape with approximately the same roundness as the large-diameter outer circumferential surface 44. That is, a plurality of convex portions 15a to 15g are formed that respectively protrude radially inward on a phase between circumferential intermediate portions of adjacent column portions 42. In FIGS. 6A to 6C, for convenience, the inner circumferential surface 45 has the same circular shape as the large-diameter outer circumferential surface 44 shown in FIG. 4.

As shown in FIGS. 6A to 6C, considering the case in which the inner circumferential surface 45 of the crown type cage 40, which is formed in the petal shape and has the same number of convex portions 15a to 15g as the column portions 42, is guided by the outer circumferential surface 32 of the shoulder portion of the inner ring 30 formed in a substantially circular shape, for example, as shown in FIG. 6B, when the outer circumferential surface 32 of the shoulder portion of the inner ring 30 is displaced diagonally upward to the left in the drawing relative to the inner circumferential surface 45, the convex portions 15a and 15g come into contact with the outer circumferential surface 32 of the inner ring 30 to restrict further movement. When the outer circumferential surface 32 of the shoulder portion of the inner ring 30 is displaced diagonally downward to the right in the drawing relative to the inner circumferential surface 45, the convex portions 15b, 15c, and 15d come into contact with the outer circumferential surface 32 of the shoulder portion of the inner ring 30, thereby restricting further movement.

Therefore, also in the case of the inner ring guide type in which the inner circumferential surface 45 of the crown type cage 40 is guided by the outer circumferential surface 32 of the inner ring 30, the practical virtual roundness of the inner circumferential surface 45 of the crown type cage 40 decreases, similar to the outer ring guide type. As a result, even in high-speed rotation under conditions of dmn of 1 million or more, the radial vibration amplitude of the crown type cage 40 can be significantly reduced, the life of the crown type cage 40 is improved, and the deep groove ball bearing 10 is made quieter.

When the crown type cage 40 is an inner ring guide type cage as in the present embodiment, the inner circumferential surface of the column portion 42 where the gate mark G is formed also approaches the outer circumferential surface of the inner ring 30. However, since the gate mark G is provided within the range L where the inner ring raceway groove 31 of the inner ring 30 is formed, it is possible to reliably prevent the burr from interfering with the outer circumferential surface 32 of the inner ring 30 even if the burr occurs in the gate mark G.

Like a crown type cage 40A of a modification as shown in FIG. 7, the outer circumferential surface of the annular portion 41 may not have a large-diameter outer circumferential surface and may have an outer diameter equal to the outer diameter of the column portion 42. Here, the parting line PL is formed from the outer circumferential surface of each column portion 42 to the outer circumferential surface of the annular portion 41.

### Third Embodiment

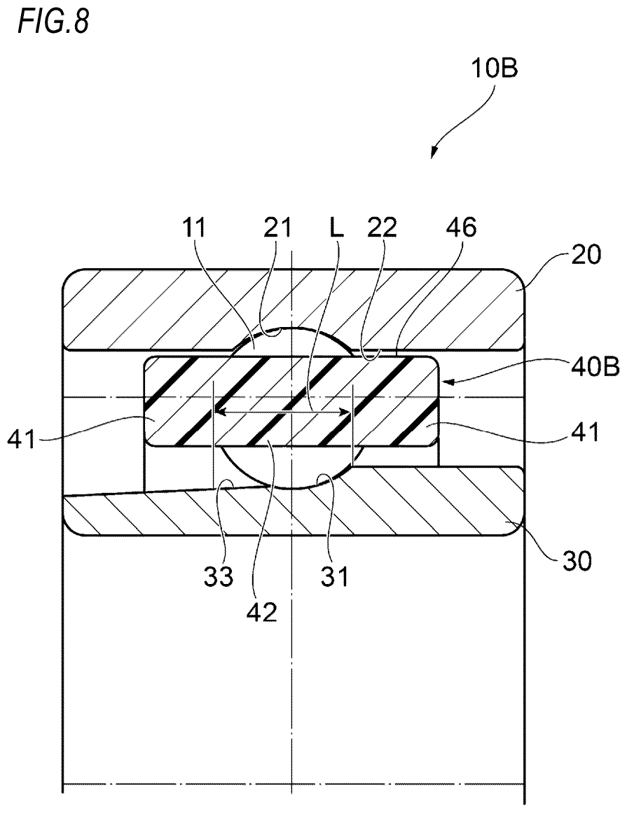

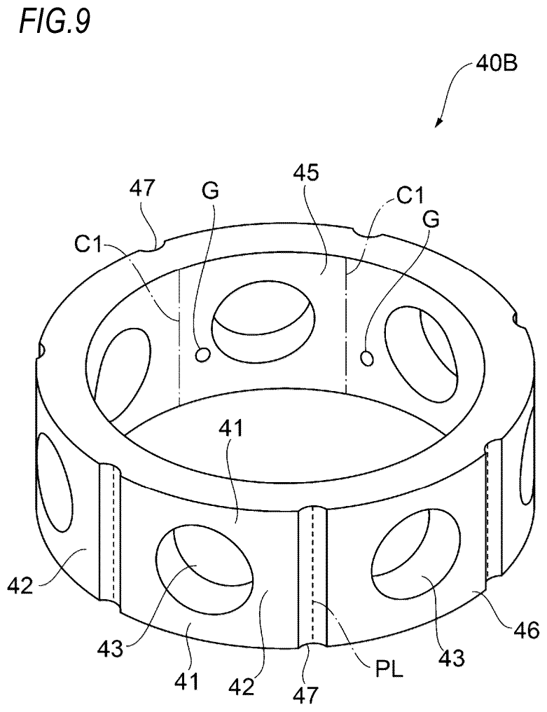

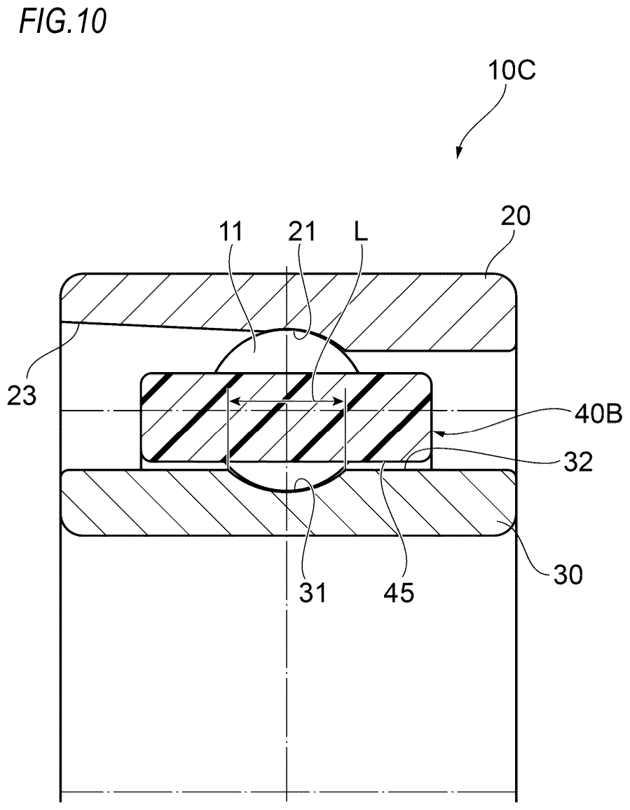

Next, an angular contact ball bearing incorporating a resin cage according to a third embodiment of the present invention will be described with reference to FIGS. 8 and 9.

An angular contact ball bearing 10B of the present embodiment has the outer ring 20 with the outer ring raceway groove 21 formed on the inner circumferential surface, the inner ring 30 with the inner ring raceway groove 31 formed on the outer circumferential surface and a counterbore 33 formed on axial one side of the outer circumferential surface, the plurality of balls 11 rotatably disposed with a contact angle between the outer ring raceway groove 21 and the inner ring raceway groove 31, and a double ring type cage 40B which is a resin cage having a plurality of (seven, in this embodiment) pockets 43 that rotatably hold the balls 11, respectively.

As shown in FIG. 9, the double ring type cage 40B includes a pair of annular portions 41 disposed opposite to each other in the axial direction, in which the pair of annular portions 41 extend in the axial direction to connect the pair of annular portions 41, and a plurality of (seven, in the embodiment shown in FIG. 9) column portions 42 arranged at equal intervals in the circumferential direction, in which the pocket 43 is formed by adjacent column portions 42 and the pair of annular portions 41. The double ring type cage 40B is an outer ring guide type, and outer circumferential surfaces 46 of the pair of annular portions 41 are guided by the inner circumferential surfaces 22 of the shoulder portions of the outer ring 20. In the present embodiment, the outer circumferential surface of the cage 40B has a uniform outer diameter except for a U-shaped groove 47, which will be described below, and therefore, the outer circumferential surfaces of the pair of annular portions 41 forming the guide surfaces have an outer diameter equal to the outer circumferential surface of the column portions 42. Note that an inner surface of the pocket 43 has a cylindrical shape, but may have a spherical shape.

The double ring type cage 40B is injection-molded by discharging resin material from a gate into a cavity formed in a radial draw mold, and the gates are open at positions corresponding to the inner circumferential surfaces of all the column portions 42 of the cavity, respectively. Therefore, the gate marks G are provided on the inner circumferential surfaces of all the column portions 42. As in the first embodiment, in the circumferential direction, the gate mark G is circumferentially displaced from the circumferential center position C1 of the column portion 42, and in the axial direction, the gate mark G is provided on the inner circumferential surface of the column portion 42, within a range L where the inner ring raceway groove 31 of the inner ring 30 and the counterbore 33 are formed when the double ring type cage 40B is assembled into the angular contact ball bearing 10B (see FIG. 8).

By arranging the gate marks G at the positions described above, the outer circumferential surface 46 of the double ring type cage 40B is formed into an uneven (petal-shaped) circular shape having the same number of convex portions 16a to 16g as the column portions 42, which protrude radially outward in all the column portions 42 with respect to a perfect circle, as in FIGS. 3A to 3C.

Therefore, the inner circumferential surface 22 of the shoulder portion of the outer ring 20 does not come into contact with any of the recesses formed between the respective convex portions 16a to 16g, and the practical virtual roundness is reduced, and the radial vibration amplitude of the outer ring guide type double ring type cage 40B can be significantly reduced even in high-speed rotation under conditions of dmn of 1 million or more.

The pockets 43 of the double ring type cage 40B are formed by a plurality of (seven, in the present embodiment) slide cores (not shown) that are movable radially outward along the center line of each pocket 43. Therefore, on the outer circumferential surface 46 of the double ring type cage 40B (that is, on the outer circumferential surfaces 46 of the annular portion 41 and the column portion 42), a parting line PL, which is a joint between the slide cores, is formed in the U-shaped groove 47 extending along the axial direction at a circumferential intermediate position between adjacent pockets 43.

By forming the parting line PL in the U-shaped groove 47 as described above, the parting line PL is prevented from protruding from the outer circumferential surface 46 of the double ring type cage 40B, and the parting line PL does not impede rotation even when the double ring type cage 40B is used in an outer ring guide type.

Other configurations and operations are the same as those described above in the first embodiment.

FIG. 10 is a longitudinal cross-sectional view of a main part of an angular contact ball bearing 10C using the double ring type cage 40B shown in FIG. 9 as an inner ring guide type. In the angular contact ball bearing 10C, a counterbore 23 is formed on axial one side of the outer circumferential surface of the inner ring 30.

Here, the inner circumferential surface 45 of the double ring type cage 40B is guided by the outer circumferential surfaces 32 of the shoulder portions on both sides of the inner ring 30 in the axial direction, and the inner circumferential surface 45 serves as guide surfaces. As in FIGS. 6A to 6C, the inner circumferential surface 45 of the double ring type cage 40B is formed into an uneven (petal-shaped) circular shape having the same number of convex portions 15a to 15g as the column portions 42, which protrude radially inward on a phase of the circumferential intermediate portion of the column portions 42 adjacent to each other with respect to a perfect circle. Therefore, as in the embodiment described above, the practical virtual roundness is reduced, and the radial vibration amplitude of the inner ring guide type double ring type cage 40B can be significantly reduced even in high-speed rotation under conditions of dmn of 1 million or more.

In the double ring type cage 40B, the gate marks G are provided on the inner circumferential surfaces of all the column portions 42. In the circumferential direction, the gate mark G is circumferentially displaced from the circumferential center position C1 of the column portion 42. In the axial direction, the gate mark G is provided within a range L where the inner ring raceway groove 31 of the inner ring 30 is formed when the double ring type cage 40B is assembled into the angular contact ball bearing 10C (see FIG. 10). Therefore, the same effects as the embodiments described above can be achieved.

### Fourth Embodiment

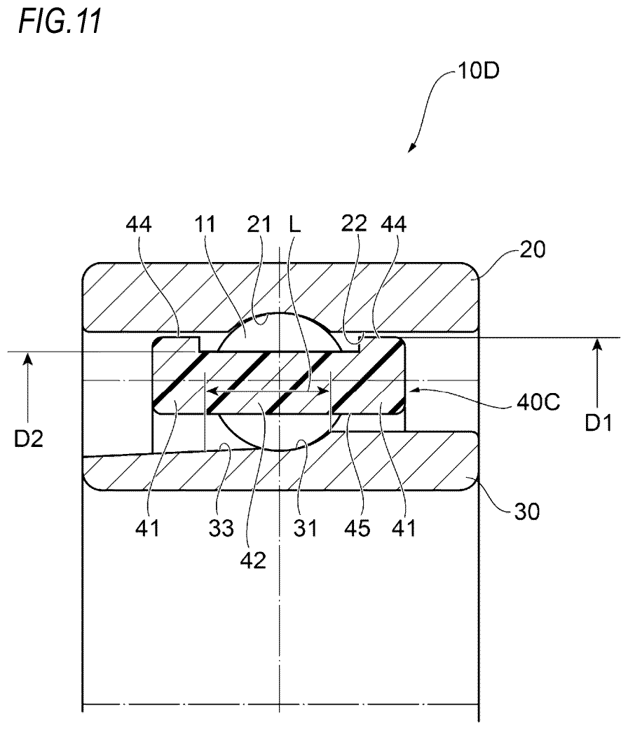

Next, an angular contact ball bearing incorporating a resin cage according to a fourth embodiment of the present invention will be described with reference to FIGS. 11 and 12.

An angular contact ball bearing 10D of the present embodiment differs from the angular contact ball bearing 10B of the third embodiment in the shape of the double ring type cage 40C which is a resin cage. That is, in the double ring type cage 40C, the large-diameter outer circumferential surface 44 having the outer diameter D1 larger than the outer diameter D2 of the column portion 42 is formed on a pair of annular portions 41 formed on both sides in the axial direction.

As shown in FIG. 12, the outer circumferential surface of each column portion 42 of the double ring type cage 40C and the pockets 43 are formed by a plurality of slide cores (not shown) that are movable radially outward along the center line of each pocket 43. Therefore, a parting line PL is formed on the outer circumferential surface of each column portion 42 of double ring type cage 40C. Since the parting line PL is formed at the bottom of the U-shaped groove 47, and the outer diameter D1 of the large-diameter outer circumferential surface 44 formed on the annular portion 41 is larger than the outer diameter D2 of the outer circumferential surface of the column portion 42, the parting line PL does not impede rotation.

Since the large-diameter outer circumferential surface 44 and the inner circumferential surface 45 of the pair of annular portions 41 are cut out from a fixed mold in the axial direction, no parting line PL is formed.

As shown in FIG. 11, the double ring type cage 40C is assembled into the angular contact ball bearing 10D, and the large-diameter outer circumferential surface 44 is guided by the inner circumferential surface 22 of the shoulder portion of the outer ring 20.

Since the double ring type cage 40C of the present embodiment has no parting line PL formed on the inner circumferential surface 45, the cage 40C can also be used as an inner ring guide type cage with the inner circumferential surface 45 as a guide surface.

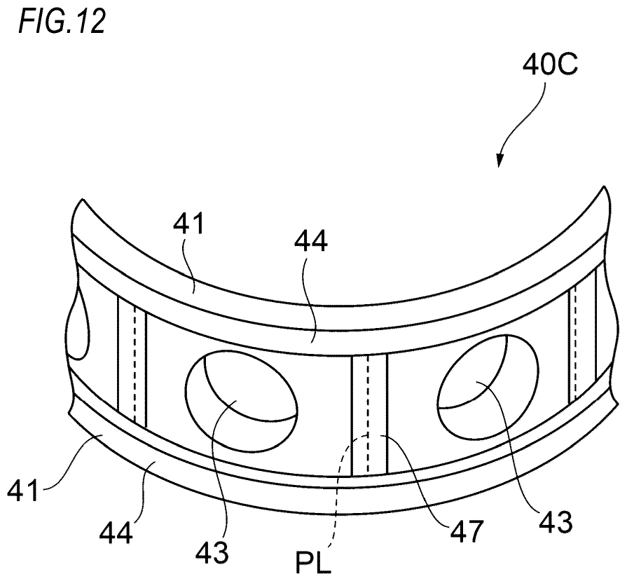

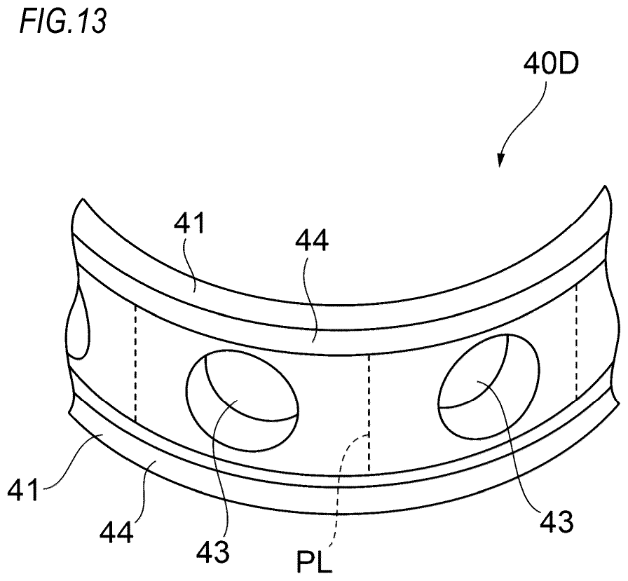

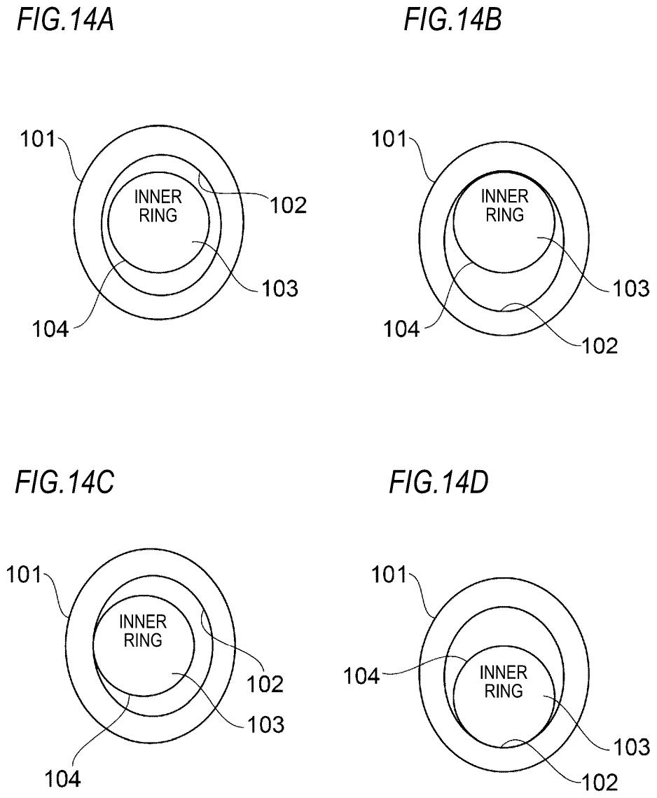

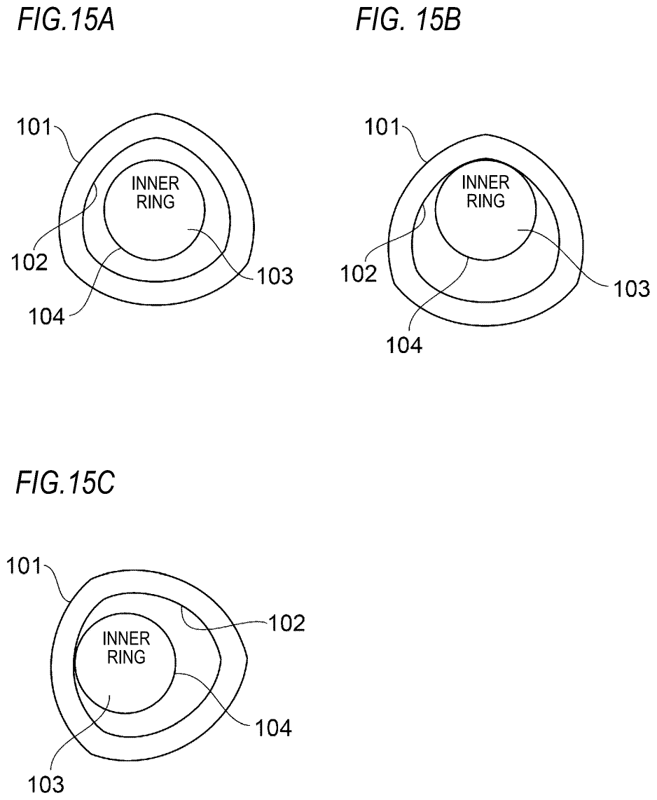

As a modification of the present embodiment, a double ring type cage 40D as shown in FIG. 13 may be used. The double ring type cage 40D does not have the U-shaped groove 47 like the double ring type cage 40C, and a parting line PL is formed on the outer circumferential surface of each column portion 42.

Here, since the double ring type cage 40D has the large-diameter outer circumferential surface 44 formed on the outer circumferential surfaces of the pair of annular portions 41, the parting line PL formed on the outer circumferential surface of the column portion 42 does not protrude radially outward from the outer circumferential surface of the large-diameter outer circumferential surface 44, and the parting line PL does not impede rotation.

Note that the present invention is not limited to the embodiments described above, and may be modified or improved as appropriate.

The application is based upon Japanese Patent Application (Application No. 2022-064691), filed on Apr. 8, 2022, the entire contents of which are incorporated herein by reference.

### REFERENCE SIGNS LIST

10, 10A deep groove ball bearing (ball bearing)
10B, 10C angular contact ball bearing (ball bearing)
11 ball
15a to 15g, 16a to 16g convex portion
40, 40A crown type cage (resin cage)
40B, 40C, 40D double ring type cage (resin cage)
41 annular portion
42 column portion
43 pocket
44 large-diameter outer circumferential surface (guide surface)
45 inner circumferential surface (guide surface)
G gate mark
L range where inner ring raceway grooves are formed

1. A resin cage for a ball bearing, the resin cage comprising: at least one annular portion; and a plurality of column portions each extending from the annular portion in an axial direction and provided at equal intervals in a circumferential direction, wherein the resin cage for the ball bearing can rotatably hold balls of the ball bearing in pockets formed between adjacent column portions, the annular portion has a guide surface that is guided by an inner circumferential surface of an outer ring or an outer circumferential surface of an inner ring of the ball bearing,
gate marks are provided on inner circumferential surfaces of all of the column portions, and
the gate marks are circumferentially displaced from a circumferential center position of the column portions.

2. The resin cage for the ball bearing according to claim 1, wherein the guide surface is guided by an inner circumferential surface of the outer ring, and
the guide surface has an uneven circular shape having convex portions protruding radially outward on a phase of all the column portions with respect to a perfect circle.

3. The resin cage for the ball bearing according to claim 2, wherein the guide surface is formed by an outer circumferential surface of the annular portion having a larger outer diameter than an outer circumferential surface of the column portion.

4. The resin cage for the ball bearing according to claim 2, wherein the guide surface is formed by an outer circumferential surface of the annular portion having an outer diameter equal to an outer circumferential surface of the column portion, and
a U-shaped groove in which a parting line extends along the axial direction is formed on the outer circumferential surface of the annular portion and the column portion at a circumferentially intermediate position between the adjacent pockets.

5. The resin cage for the ball bearing according to claim 1, wherein the guide surface is guided by an outer circumferential surface of the inner ring, and
the guide surface has an uneven circular shape having convex portions protruding radially inward on a phase of all the column portions with respect to a perfect circle.

6. The resin cage for the ball bearing according to claim 1, wherein the resin cage is a crown type cage or a double ring type cage having a pair of annular portions.

7. A ball bearing comprising:
an outer ring with an outer ring raceway groove formed on an inner circumferential surface;
an inner ring with an inner ring raceway groove formed on an outer circumferential surface;
a plurality of balls rotatably disposed between the outer ring raceway groove and the inner ring raceway groove; and
the resin cage for the ball bearing according to claim 1, wherein
the gate mark is provided within a range where the inner raceway groove is formed in an axial direction, or within a range where the inner raceway groove and a counterbore of the inner ring are formed.

8. A method for manufacturing a resin cage for a rolling bearing, the resin cage comprising at least one annular portion, and a plurality of column portions each extending from the annular portion in an axial direction and provided at equal intervals in a circumferential direction, wherein the resin cage for the ball bearing can rotatably hold balls of the ball bearing in pockets formed between adjacent column portions, the annular portion has a guide surface that is guided by an inner circumferential surface of an outer ring or an outer circumferential surface of an inner ring of the ball bearing,
the resin cage is injection-molded using a radial draw mold,
gates are provided on the inner circumferential surface of all the column portions, and
the gates are circumferentially displaced from a circumferential center position of the column portion.
